(19) United States
(12) Patent Application Publication
(10) Pub. No.: US 2005/0168892 A1
(43) Pub. Date: Aug. 4, 2005

(54) Electric power steering system

(76) Inventors: Yoshihide Kuroda, Nagoya-city (JP); Yoshitaka Hayashi, Obu-city (JP)

Correspondence Address: HARNESS, DICKEY & PIERCE, P.L.C., P.O. BOX 828, BLOOMFIELD HILLS, MI, 48303, US

(21) Appl. No.: 11/046,578

(22) Filed: Jan. 28, 2005

(30) Foreign Application Priority Data
Jan. 29, 2004 (JP) 2004-020876

(51) Int. Cl. H02H 3/00

(52) U.S. Cl. 361/42

(57) ABSTRACT

An electronic control unit (ECU) stops driving a first switching transistor in a step-up circuit until an actual ground fault is determined after a possible ground fault is detected in a line that is electrically connected with an electric motor. As a result, a voltage stepped-up by the step-up circuit is controlled. Since current flowing through the electric motor does not sharply decrease immediately after the possible ground fault is detected in the line, unusual power steering movement is less likely to be produced. Moreover, switching transistors in an H bridge circuit, which is a motor drive circuit, are protected from damage because no excess voltage is applied to the switching transistors.

### CROSS REFERENCE TO RELATED APPLICATION

This application is based on and incorporates herein by reference Japanese Patent Application No. 2004-20876 filed on Jan. 29, 2004.

### FIELD OF THE INVENTION

The present invention relates to an electric power steering system.

### BACKGROUND OF THE INVENTION

An electric power steering system, in general, has an electric motor for increasing steering force, an inverter for driving the motor, a control circuit for controlling the inverter, and a step-up circuit for stepping up a source voltage and supplying power to the inverter. The control circuit measures current flowing through the inverter with a shunt resistor connected downstream of the inverter. If the current is smaller than a target current, the control circuit controls the step-up circuit to increase the source voltage.

The control circuit determines whether a ground fault is present between the motor and a switching component that is included in the inverter when a possible ground fault is detected. Specifically, the control circuit starts a counter immediately after the possible ground fault is detected and determines an actual ground fault when the count of the counter reaches an abnormal level. The control circuit maintains the switching component turned on for a predetermined period after the possible ground fault is detected until the count of the abnormal operation counter reaches an abnormal level. The control circuit turns off the switching component when the actual ground fault is determined.

The control circuit keeps increasing the source voltage through the step-up circuit until the count reaches the abnormal level when the ground fault is actually present because no current flows through the shunt resistor. An excess voltage is applied to the switching element resulting in a failure of the switching element.

To solve this problem, an apparatus in which a switching element is immediately turned off when a possible ground fault is detected is proposed in JP-A-5-185937. However, steering assisting power suddenly decreases if a control circuit turns off a switching component immediately after a possible ground fault is detected. As a result, a driver may experience unusual feeling in steering.

### SUMMARY OF THE INVENTION

The present invention therefore has an objective to provide an electric power steering system having a function for protecting a switching component when a possible ground fault is detected without producing unusual power steering movement. An electric power steering system of the present invention includes an electric motor, a motor drive circuit, power supply circuit, control unit, possible ground fault detecting means, and an actual ground fault determining means.

The electric motor generates power for assisting in steering of a vehicle. The motor drive circuit that is connected with the electric motor includes a switching component and controls current flowing through the electric motor with the switching component. The power supply circuit includes a step-up circuit for stepping up a source voltage and applies the stepped-up voltage to the electric motor via the switching component. The control unit controls step-up operation of the step-up circuit and drive of the switching component.

The possible ground fault detecting means detects a possible ground fault in a line electrically connected to the electric motor. The actual ground fault determining means determines whether a ground fault is actually present in the line when the possible ground fault is detected. The control unit includes application voltage control means that continues driving the switching component until the actual ground fault is determined after the possible ground fault is detected. The application voltage control means also controls a voltage applied to the switching component by the power supply circuit.

With this configuration, current flowing through the electric motor does not sharply decrease immediately after the possible ground fault is detected in the line. As a result, unusual power steering movement is less likely to be produced after the possible ground fault is detected. Furthermore, no excess voltage is applied to the switching component after the possible ground fault is detected because the application voltage control means controls the voltage applied to the switching component. Thus, the switching component is protected from damage.

### BRIEF DESCRIPTION OF THE DRAWINGS

The above and other objectives, features and advantages of the present invention will become more apparent from the following detailed description made with reference to the accompanying drawings. In the drawings:

FIG. 1 is a block diagram of an electric power steering system according to an embodiment of the present invention;

FIG. 2 is a circuit diagram of a step-up circuit included in the electric power steering system according to the embodiment;

FIG. 3 is a flowchart of a step-up circuit control process performed by an electronic control unit included in the electric power steering system according to the embodiment; and

FIG. 4 is a flowchart of a power supply control process performed by the electronic control unit when a ground fault is detected according to the embodiment.

### DETAILED DESCRIPTION OF THE PREFERRED EMBODIMENT

The preferred embodiment of the present invention will be explained with reference to the accompanying drawings. In the drawings, the same numerals are used for the same components and devices.

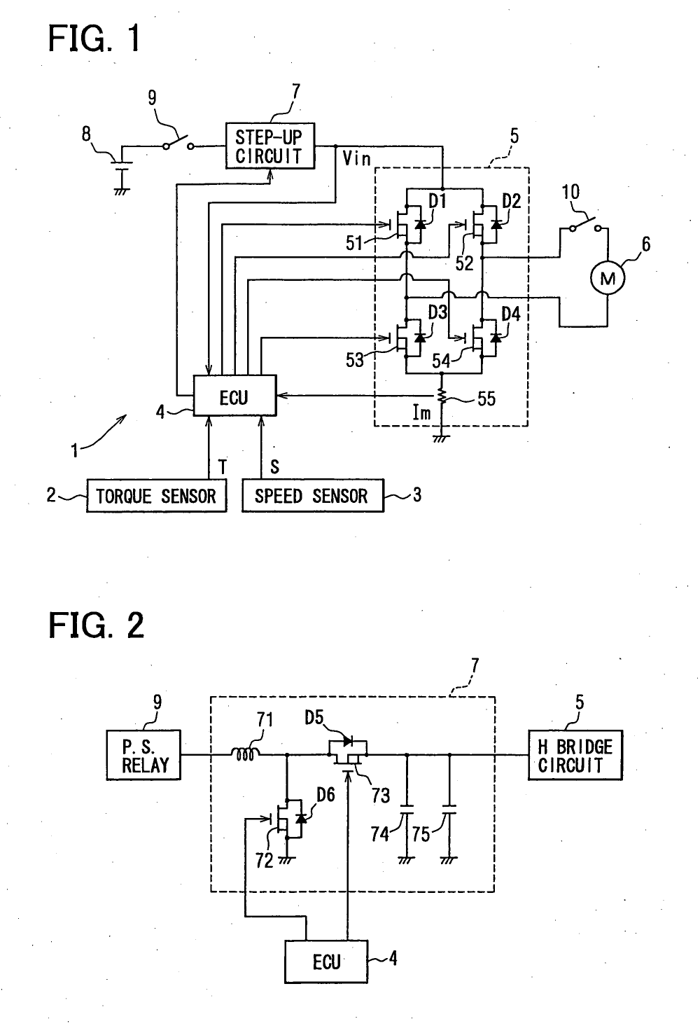

Referring to FIG. 1, an electric power steering system 1 includes a torque sensor 2, an electronic control unit (ECU) 4, an H bridge circuit 5, and an electric motor 6. The H bridge circuit 5 is a motor drive circuit. The torque sensor 2 detects a torque signal T that indicates steering torque applied to a steering wheel (not shown) and outputs the detected torque signal T to the ECU 4.

The ECU 4 receives the torque signal T and a speed signal S that is detected by a speed sensor 3 and calculates a target current Ima based on the torque signal T and the speed signal S. The target current Ima will be passed to the motor 6. The ECU 4 detects the current Im that actually flows through the motor 6 with a shunt resistor 55 provided in the H bridge circuit 5. The ECU 4 outputs a PWM driving signal to perform duty cycle control on four switching transistors 51 through 54, which are switching components, based on a deviation between the actual current Im and the target current Ima so that the actual current Im matches the target current Ima.

The ECU 4 regularly monitors a stepped-up voltage Vin stepped up by a step-up circuit 7 and determines a possible ground fault in lines electrically connected with the motor 6 when the stepped-up voltage Vin is higher than a reference voltage Vs. The lines electrically connected with the motor 6 includes lines that connect the motor 6 with the H bridge circuit 5, lines within the H bridge circuit 5, lines that connect the H bridge circuit 5 with the step-up circuit 7, and lines within the step-up circuit 7. The reference voltage Vs is predetermined within a normal voltage range in which a voltage is applied to the H bridge circuit 5.

The ECU 4 starts incrementing a counter in a predetermined interval when a possible ground fault is detected. The ECU 4 determines a ground fault in the line when the counter is incremented to a reference value. The ECU 4 then turns off all four switching transistors 51 trough 54 in the H bridge circuit 5 and opens a power source relay 9. When the count of the counter has not reached the abnormal level, the ECU 4 determines no ground fault is present in the line and performs regular control operation.

The H bridge circuit 5 has diodes D1 through D4 in addition to the above described switching transistors 51 through 54. The switching transistors 51 through 54 and respective diodes D1 through D4 are connected with the motor 6 in the form of H bridge connection. The H bridge circuit 5 controls the current flowing through the motor 6 based on the PWM drive signal outputted from the ECU 4. The switching transistors 51, 52 and the diodes D1, D2 are connected to a battery 8 via the step-up circuit 7 and the power source relay 9. The transistor 53, 54 and the diodes D3, D4 are grounded via the shunt resistor 55.

The shunt resistor 55 is provided for detecting the current flowing through the bridge circuit 55, that is, the current Im flowing through the motor 6 by the ECU 4. The motor 6 is electrically connected to the transistor 52 via a motor relay at one end and to the transistor 53 at the other end. The stepped-up voltage Vin stepped up by the step-up circuit 7 is applied to the H bridge circuit 5.

The step-up circuit 7 is electrically connected to the battery 8 via the power source relay 9 at one end and with the H bridge circuit 5 at the other end. The step-up circuit 7 includes a coil 71, the first transistor 72, the second transistor 73, diodes D5, D6 and capacitors 74, 75 as shown in FIG. 2. The first transistor 72 is step-up means for stepping up the source voltage. The second transistor 73 is stepped-up voltage supplying means for supplying the stepped-up voltage to the motor 6. The step-up circuit 7 and the battery 8 form a power supply circuit.

The coil 71 is electrically connected to the battery 8 via the power source relay 9 at one end and with the first and the second transistors 72, 73 at the other end. The first transistor 72 turns on and off according to control signals outputted from the ECU 4, namely, the ECU 4 drives the first transistor 72 while controlling a duty cycle of the first transistor 72. The source voltage is stepped up according to the switching operation of the first transistor 72. The second transistor 73 turns on and off according to control signals outputted from the ECU 4, namely, the ECU drives the second transistor 73 while controlling a duty cycle of the second transistor 73. The stepped-up voltage Vin is outputted to the H bridge circuit 5 according to the switching operation of the second transistor 73.

The ECU 4 controls the first and the second transistor 72, 73 so that they do not perform the switching operation at the same time. More specifically, the ECU 4 does not output a control signal to the second transistor 73 while it is outputting a control signal to the first transistor 72. It does not output a control signal to the first transistor 72 while it is outputting a control signal to the second transistor 73. The capacitors 74, 75 charge and smooth the stepped-up voltage Vin.

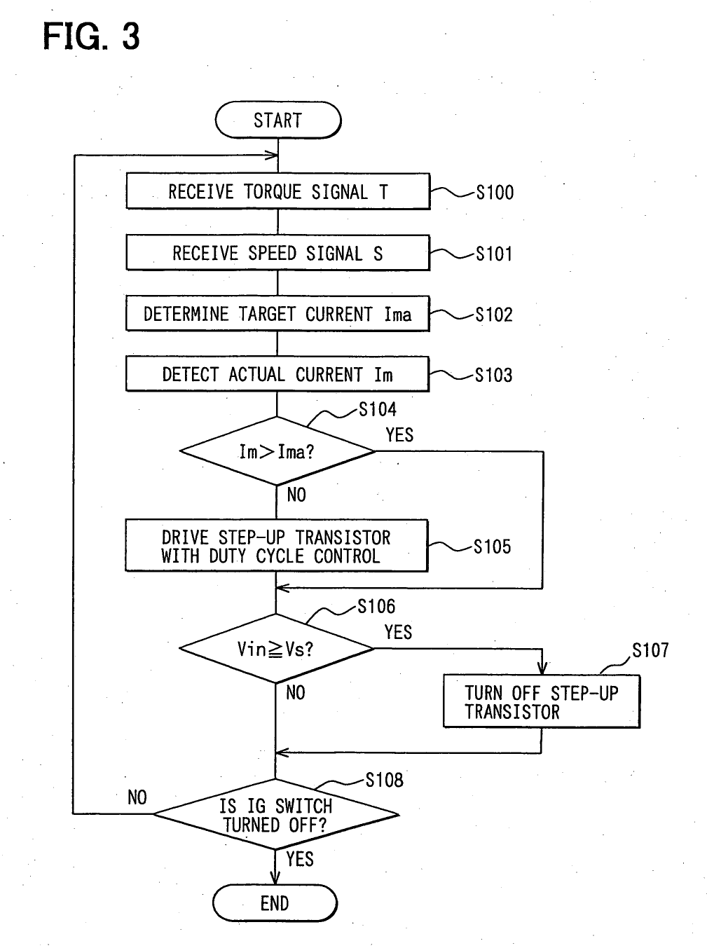

The ECU 4 controls the step-up circuit 7 according to steps shown in FIG. 3. It receives the torque signal T detected by the torque sensor 2 (S100) and the speed signal S detected by the speed sensor 3 (S101). It determines the target current Ima based on the torque signal T and the speed signal S (S102). It detects the actual current Im flowing through the motor 6 with the shunt resistor 55 (S103). It determines whether the detected actual current Im is larger than the target current Ima (S104). If not, it drives the first transistor 72 with the duty cycle control for stepping up the source voltage to increase the actual current Im close to the target current Ima (S1005).

After this step or if the actual current Im is larger than the target current Ima, the ECU 4 determines whether the step-up voltage Vin is equal to or higher than the reference voltage Vs (S106). If so, the ECU 4 detects a possible ground fault in the lines electrically connected with the motor 6 and turns off the first transistor 72 until an actual ground fault is determined (S107). Namely, the battery voltage is not stepped up until an actual ground fault is detected since the ECU 4 does not output a control signal to the first transistor 72. The ECU 4 continues driving the switching transistors 51 through 54 in the H bridge circuit 5 and the second transistor 73 while controlling their duty cycles.

If the step-up voltage Vin is lower than the reference voltage Vs, the ECU 4 determines whether an ignition (IG) switch (not shown) is turned off (S108). If the IG switch is turned off, the ECU 4 terminates the process. If the IG switch is not turned off, the ECU4 repeats the above described steps.

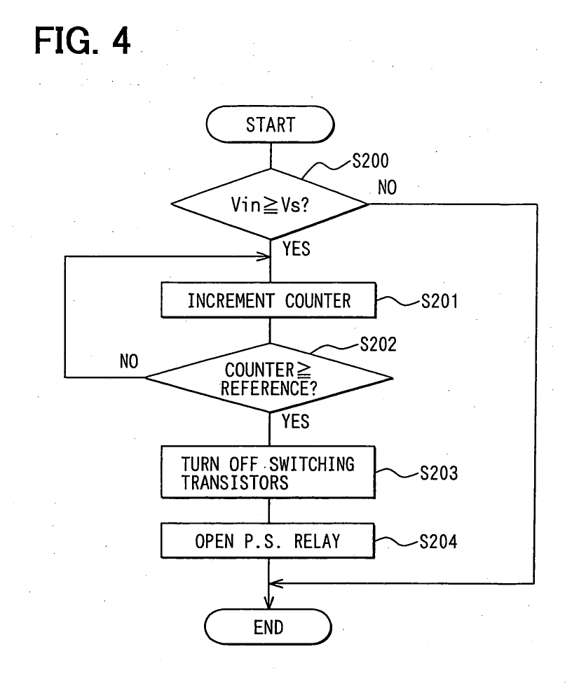

The ECU 4 determines an actual ground fault in a line electrically connected with the motor and controls power supply to the switching transistors 51 through 54 as shown in FIG. 4. It determines whether the stepped-up voltage Vin is equal to or higher than the reference voltage Vs (S200). If not, it terminates this process. If so, it starts incrementing the counter (S201). It determines whether the counter is incremented to the reference value (S202). If not, it continues incrementing the counter. If so, it turns off the switching transistors 51 through 54 (S203) and opens the power source relay 9 (S204).

The ECU 4 turns off the first transistor 72 to maintain the step-up voltage Vin until an actual ground fault in a line electrically connected with the motor 6 is determined after a possible ground fault is detected. Therefore, the amount of current flowing through the motor 6 does not suddenly decrease immediately after a possible ground fault is detected in a line electrically connected with the motor 6. Namely, the driver is less likely to experience unusual feeling in steering even when a possible ground fault is detected. Moreover, the switching transistors 51 through 54 are protected from an excess voltage because a voltage applied to the H bridge circuit 5, that is, the step-up voltage is maintained at a proper level.

The ECU 4 continues driving the second transistor 73 while controlling the duty cycle until an actual ground fault is determined after a possible ground fault is detected in a line electrically connected with the motor 6. Thus, the step-up voltage Vin charged in the capacitors 74, 75 is feedback to the battery 8 and the voltage applied to the switching transistors 51 through 54 is gradually reduced.

The ECU 4 opens the power source relay 9 when an actual ground fault is detected in a line electrically connected with the motor 6. Namely, the electrical connection between the battery 8 and the switching transistors 51 through 54 is lost and the battery voltage is not applied to the switching transistors 51 through 54. Therefore, safety operation of the switching transistors 51 through 54 is assured. Moreover, the ECU 4 turns off all four switching transistors 51 through 54 in the H bridge circuit 5 when the actual ground fault is detected. Thus, safety operation of the switching transistors 51 through 54 is doubly assured.

A current does not flow through the shunt resistor 55 when a ground fault is actually present in a line electrically connected with the motor 6. The ECU 4 drives the second transistor 73 to step up the battery voltage so that the actual current Im flowing through the motor 6 matches the target current Ima. A ground fault is possibly present in a line electrically connected with the motor 6 if the step-up voltage Vin becomes higher than the normal range. Thus, the ECU 4 regularly monitors the step-up voltage Vin and detects a possible ground fault in the line based on the step-up voltage Vin.

The present invention should not be limited to the embodiment previously discussed and shown in the figures, but may be implemented in various ways without departing from the spirit of the invention. For example, the second transistor 73 may be driven with duty cycle control until an actual ground fault is detected in a line electrically connected with the motor 6. The H bridge circuit 5 can be replaced by a brushless motor, which is an inverter having six switching transistors configured in the same manner as the switching transistors 51 through 54.

1. An electric power steering system comprising:
an electric motor that generates power for assisting in steering of a vehicle;
a motor drive circuit that includes a switching component for controlling current flowing through the electric motor;
a power supply circuit that includes a step-up circuit for stepping up a power source voltage and applies the stepped up power source voltage to the electric motor via the switching component;
a control unit that controls step-up operation of the power source voltage in the step-up circuit and drive of the switching component;
possible ground fault detecting means that detects a possible ground fault in a line electrically connected with electric motor; and
actual ground fault determining means that determines an actual ground fault, which is a ground fault actually present in the line,
wherein the control unit includes application voltage control means that controls a voltage applied to the switching component by the power supply circuit.

2. The electric power steering system according to claim 1, wherein the application voltage control means controls the voltage by restricting step-up operation of the step-up circuit.

3. The electric power steering system according to claim 2, wherein:
the step-up circuit includes step-up means that steps up the power source voltage;
the motor drive circuit is an inverter having a plurality of switching components, operation of the inverter being controlled by the control unit with duty cycle control;
the control unit drives the step-up circuit when a current flowing through the inverter is smaller than a target current; and
the application voltage control means restricts the step-up operation of the step-up circuit by halting operation of the step up means.

4. The electric power steering system according to claim 3, wherein:
the step-up circuit includes stepped-up voltage applying means, and a coil that is connected between the power source and the step-up voltage applying means; and
the step-up means is a first switching transistor that is electrically connected to the coil at one end and to a ground at another end.

5. The electric power steering system according to claim 4, wherein:
the step-up circuit further includes a capacitor that charges a voltage stepped up by the step-up means;
the stepped-up voltage supplying means is a second switching transistor that is electrically connected to the coil at one end and to the switching component at another end; and
the application voltage control means drives the second switching transistor.

6. The electric power steering system according to claim 1, further comprising a power source relay that interrupts power supply from the power source to the step-up circuit, wherein the control unit turns off the power source relay when the actual ground fault is determined.

7. The electric power steering system according to claim 1, wherein the control unit stops driving the switching component when the actual ground fault is determined.

8. The electric power steering system according to claim 1, wherein the possible ground fault detecting means detects the possible ground fault based on a voltage applied to the motor drive circuit, the voltage being higher than a reference voltage.

9. The electric power steering system according to claim 8, wherein the reference voltage is predetermined within a normal voltage range in which a voltage is applied to the motor drive circuit.

10. The electric power steering system according to claim 1, wherein:
the possible ground fault detecting means detects a possible ground fault in a line that electrically connects the electric motor with the motor drive circuit; and
the actual ground fault determining means determines an actual ground fault in the line that electrically connects the electric motor with the motor drive circuit.

11. The electric power steering system according to claim 1, wherein:
the possible ground fault detecting means detects a possible ground fault in a line inside the motor drive circuit; and
the actual ground fault determining means determines an actual ground fault in the line inside the motor drive circuit.

12. The electric power steering system according to claim 1, wherein:
the possible ground fault detecting means detects a possible ground fault in a line that electrically connects the motor drive circuit with the power supply circuit; and
the actual ground fault determining means determines an actual ground fault in the line that electrically connects the motor drive circuit with the power supply circuit.

13. The electric power steering system according to claim 1, wherein
the possible ground fault detecting means detects a possible ground fault in a line inside the step-up circuit; and
the actual ground fault determining means determines an actual ground fault in the line inside the step-up circuit.
